(19) United States
(12) Patent Application Publication
(10) Pub. No.: US 2025/0314421 A1
(43) Pub. Date: Oct. 9, 2025

(54) REFRIGERATOR

(71) Applicant: LG Electronics Inc., Seoul (KR)

(72) Inventor: Jung Mi KIM, Seoul (KR)

(21) Appl. No.: 19/169,209

(22) Filed: Apr. 3, 2025

(30) Foreign Application Priority Data
Apr. 3, 2024 (KR) 10-2024-0045204

(51) Int. Cl. F25D 27/00

(52) U.S. Cl. CPC F25D 27/00; F25D 2400/18

(57) ABSTRACT

A refrigerator provides, by a plurality of bezels surrounding the periphery of a light guiding assembly and being fastened to one another via a male-female coupling structure, a fitting structure between the bezels, which is capable of minimizing the fastening structure step between the bezels even in a storage chamber with limited space.

### CROSS-REFERENCE TO RELATED APPLICATION

This application claims priority to and the benefit of Korean Patent Application No. 10-2024-0045204, filed on Apr. 3, 2024, the disclosure of which is incorporated herein by reference in its entirety.

### BACKGROUND

The present invention relates to a refrigerator.

A refrigerator is a home appliance that supplies cold air generated by utilizing the circulation of refrigerant to a storage chamber, thereby keeping various types of storage objects fresh for a long period of time.

Meanwhile, the storage chamber is equipped with a lighting device which, when opening the door, enables a user to easily check the storage objects therein.

For example, in the case where the lighting device is installed in the storage chamber, it may be installed in a certain region on the side surface of the storage chamber to illuminate the inside of the storage chamber.

However, in such case as it is installed in a certain region on the side surface of the storage chamber, there may be a problematic situation where the lighting device is blocked by the storage objects therein, as well as where it is difficult to evenly illuminate the entire region in the storage chamber.

To overcome this, a lighting device in the form of a surface lighting device with a large area that can illuminate the front surface of the storage chamber may be installed at the rear surface of the storage chamber.

Installing a surface lighting device at the rear surface of the storage chamber in this way has the advantage of not only being able to illuminate the entire region in the storage chamber evenly to the maximum extent, but also being able to illuminate the inside of the storage chamber regardless of the locations of the storage objects therein.

However, in the case of a lighting device in a form of a surface lighting device installed at the rear surface of a storage chamber, a lighting device coupling structure with strong fixing power that can withstand the self-weight of the lighting device itself may be required.

Additionally, since the surface lighting device inherently requires minimizing the coupling structure in the central region, sagging may occur in the central region.

Therefore, there may be a need for a coupling structure of a lighting device, which can reduce the occurrence of distortion of a bezel that forms and supports the exterior of the lighting device, and can reinforce the strength thereof to reduce the sagging of the lighting device.

### SUMMARY

A purpose of the present invention is to provide a refrigerator capable of minimizing a fastening structure step between bezels even in a storage chamber with limited space.

In addition, another purpose of the present invention is to provide a refrigerator capable of reducing the reliability deterioration of the fitting structure between bezels that may occur due to heat of a light source module.

In addition, still another purpose of the present invention is to provide a refrigerator having a bezel fitting structure of a lighting assembly having an electrostatic discharge (ESD) prevention function.

In addition, yet still another purpose of the present invention is to provide a refrigerator capable of reducing the occurrence of vertical separation of a male-female coupling structure or an error in the joining position caused by the self-weight of a light guiding assembly.

In addition, a further purpose of the present invention is to provide a refrigerator capable of preventing a bezel from protruding in an up and down direction.

In addition, still a further purpose of the present invention to provide a refrigerator giving the user an improved aesthetic sense in the design finish of the lighting device.

In addition, yet a further purpose of the present invention is to provide a refrigerator capable of preventing damage to a light source module that may occur during the fitting process between bezels.

In addition, yet still a further purpose of the present invention is to provide a refrigerator capable of reducing the occurrence of deformation or distortion phenomena of a bezel and reinforcing the strength of the fitting structure between bezels.

In addition, another purpose of the present invention is to provide a refrigerator capable of reducing the occurrence of alignment errors between a light guiding assembly and a light source module.

In addition, still another purpose of the present invention is to provide a refrigerator capable of improving the environmental reliability of a lighting assembly.

A refrigerator according to an embodiment of the present invention for accomplishing the above-described purpose includes a cabinet including one or more storage chambers, and a lighting assembly disposed at the inner rear of the storage chamber, wherein the lighting assembly includes a light guiding assembly, a plurality of bezel parts surrounding the periphery of the light guiding assembly, and a light source module irradiating light to the light guiding assembly, and wherein the plurality of bezel parts adjacent to each other are fastened to each other via a male-female coupling structure.

The plurality of bezel parts may include one or more male bezels and one or more female bezels, the male bezel may include a protruding coupling part protruding outward from at least one end, and the female bezel may include a coupling hole recessed inward from at least one end for the protruding coupling part to be inserted into.

The male-female coupling structure may be a coupling structure in which the male bezel is inserted in the lateral direction of the female bezel, so that the protruding coupling part is inserted into and fastened to the coupling hole.

The male bezel may be a side bezel extending in an up and down direction of the light guiding assembly to surround one side surface of the light guiding assembly, the female bezel may be an upper bezel extending in a left and right direction of the light guiding assembly to surround the upper surface of the light guiding assembly, and the end of the protruding coupling part may be positioned lower than the uppermost surface of the upper bezel.

The protruding coupling part of the side bezel may support the bottom of one side end of the upper bezel.

The side bezel may include a pair of the protruding coupling parts protruding outward from both ends, the light source module may be disposed in the side bezel so that it extends in an up and down direction to face the side surface of the light guiding assembly, and the light source module may be disposed between the pair of protruding coupling parts.

The male bezel may be a side bezel extending in an up and down direction of the light guiding assembly to surround another side surface of the light guiding assembly, the female bezel may be a lower bezel extending in a left and right direction of the light guiding assembly to surround the lower surface of the light guiding assembly, and the end of the protruding coupling part may be positioned higher than the lowermost surface of the lower bezel.

The one side end of the lower bezel may support the bottom of the protruding coupling part of the side bezel.

The side bezel may include a pair of the protruding coupling parts protruding outward from both ends, the light source module may be disposed in the side bezel so that it extends in an up and down direction to face the side surface of the light guiding assembly, and the light source module may be disposed between the pair of protruding coupling parts.

A refrigerator according to another embodiment of the present invention for accomplishing the above-described purpose includes a cabinet including one or more storage chambers, and a lighting assembly disposed at the inner rear of the storage chamber, wherein the lighting assembly includes a light guiding assembly, a plurality of bezel parts surrounding the periphery of the light guiding assembly, a coupling bracket connecting the plurality of bezel parts adjacent to each other, and one or more light source modules irradiating light to the light guiding assembly, and wherein the plurality of bezel parts adjacent to each other are joined to each other in a first direction, and the coupling bracket is joined to the plurality of bezel parts adjacent to each other in a second direction perpendicular to the first direction.

The first direction may be a direction toward the edge part of the light guiding assembly, and the second direction may be the light-emitting direction of the lighting assembly.

The plurality of bezel parts may include a first bezel and a second bezel, and the first bezel and the second bezel may be extended perpendicular to each other and fastened at respective one ends thereof via a male-female coupling structure.

The one side and another side of the coupling bracket may be respectively fastened with the rear surface of the first bezel and the rear surface of the second bezel.

The coupling bracket may include a first bracket extension part extending along an extension direction of the first bezel, a second bracket extension part extending along an extension direction of the second bezel, and a bent part connecting between the first bracket extension part and the second bracket extension part.

The refrigerator may further include a plurality of fastening members that respectively fasten the one side and the other side of the coupling bracket to the rear surface of the first bezel and the rear surface of the second bezel, and the plurality of fastening members may press the coupling bracket in the second direction.

A first protruding part and a second protruding part may be respectively disposed on the rear surface of the first bezel and the rear surface of the second bezel to protrude backward, and the coupling bracket may include a first through hole and a second through hole through which the first protruding part and the second protruding part penetrate, respectively.

The plurality of bezel parts may include an upper bezel and a lower bezel that surround the upper and lower surfaces of the light guiding assembly, respectively, and each of the upper bezel and the lower bezel may include one or more support ribs that support the rear surface of the light guiding assembly.

The plurality of bezel parts may include a pair of side bezels respectively surrounding both side surfaces of the light guiding assembly, and the light source module may be disposed on each of the pair of side bezels so as to face the edge part of the light guiding assembly.

Each of the pair of side bezels may have a buffer member disposed thereon to support the rear surface of the light guiding assembly.

The refrigerator may further include a cold air duct disposed on the rear surface of the lighting assembly, the bezel part may have one or more hook parts on the rear surface thereof, and the cold air duct may have one or more hook coupling holes in the front surface thereof, which the hook part is inserted into and fastened to.

A refrigerator according to the present invention can provide, by a plurality of bezels surrounding the periphery of a light guiding assembly and being fastened to one another via a male-female coupling structure, a fitting structure between the bezels, which is capable of minimizing the fastening structure step between the bezels even in a storage chamber with limited space.

In addition, the refrigerator according to the present invention can reduce, by a plurality of bezels surrounding the periphery of the light guiding assembly and being fastened to one another via a male-female coupling structure, the reliability deterioration of the fitting structure between the bezels even when thermal deformation occurs in the bezels due to the heat of the light source module.

In addition, the refrigerator according to the present invention can, by forming a plurality of bezel parts fastened to one another in a male-female coupling structure as injection molding products including a material having electrical insulation property, have an electrostatic discharge (ESD) prevention function that prevents static electricity from being introduced into a storage chamber through the bezel part in contact with the light source module, and also allow the bezel part to be formed quickly and easily to have male-female coupling structures of various shapes.

In addition, in a male-female coupling structure in which the upper bezel or the lower bezel has a male structure and the side bezel has a female structure, the refrigerator according to the present invention can reduce, by allowing a protruding coupling part of the male bezel to be inserted into a coupling hole of the female bezel in a lateral direction, the occurrence of an error in the joining position or the separation of the male-female coupling structure in the up and down direction due to the self-weight of the light guiding assembly acting in a downward direction.

Additionally, in a male-female coupling structure in which the upper bezel or the lower bezel has a male structure and the side bezel has a female structure, the refrigerator according to the present invention can be configured such that the end of the protruding coupling part is positioned lower than the uppermost surface of the upper bezel or higher than the lowermost surface of the lower bezel, thereby being capable of preventing the bezel from protruding in the up and down direction.

Accordingly, not only can the vertical separation of the male-female coupling structure or the occurrence of an error in the joining position due to the self-weight of the light guiding assembly acting in the downward direction be reduced, but also an improved aesthetic sense of the design finish of the lighting device can be provided to the user.

In addition, the refrigerator according to the present invention includes a pair of protruding coupling parts protruding outward from both ends of the side bezel, and a light source module disposed between the pair of protruding coupling parts, so that the protruding coupling parts can serve as a breakage prevention structure which can prevent breakage of the light source module that may occur during the fitting process between the bezels.

Additionally, the refrigerator according to the present invention can reduce the occurrence of deformation or distortion of the bezel that may occur due to thermal deformation or the self-weight of the light guiding assembly, and also reinforce the strength of the fitting structure between the bezels, by joining in a first direction a plurality of bezel parts adjacent to each other and additionally disposing a coupling bracket in a second direction perpendicular to the first direction to be joined to a plurality of bezel parts adjacent to each other.

Additionally, in an edge-type lighting assembly in which a light source module is disposed at least one side surface of the light guiding assembly to irradiate light toward the side surface of the light guiding assembly, the refrigerator according to the present invention can store the light guiding assembly and the light source module in bezels having a highly reliable fitting structure by reducing the occurrence of deformation or distortion of the bezel, thereby being capable of reducing the occurrence of alignment errors between the light guiding assembly and the light source module.

Accordingly, the lighting assembly can be maintained to emit light uniformly, and reduce the deterioration of the lighting reliability of the lighting assembly and the reliability of the bezels' fitting structure due to changes in the environment within the storage chamber, thereby be capable of increasing the environmental reliability of the lighting assembly.

### BRIEF DESCRIPTION OF DRAWINGS

FIGS. 1 and 2 are front views of a refrigerator with the door closed and open, respectively.

FIG. 3 is a perspective view of a lighting assembly and a cold air duct.

FIG. 4 is an exploded perspective view of the lighting assembly.

FIGS. 5 and 6 are front and rear perspective views, respectively, of bezel parts joined to one another according to one embodiment.

FIGS. 7 to 9 are exploded perspective views of bezel parts according to different embodiments, respectively.

FIGS. 10, 11, and 12 show an upper bezel, a lower bezel, and a side bezel, respectively.

FIG. 13 shows a light source module.

FIG. 14 is an enlarged view of a portion of the side bezel to which the light source module is fastened.

FIG. 15 is a front view of the lighting assembly.

FIGS. 16, 18 and 19 are cross-sectional views of a portion of FIG. 15, and FIG. 17 is an enlarged view of a portion of FIG. 15.

FIG. 20 is a rear view of the lighting assembly.

FIGS. 21 and 22 are views before and after a coupling bracket is joined to the lighting assembly, respectively.

FIG. 23 is an enlarged view of a corner of the lighting assembly with the coupling bracket joined.

FIG. 24 is an enlarged view of a corner portion of the lighting assembly to which a coupling bracket according to another embodiment has been joined.

### DETAILED DESCRIPTIONS

Hereinafter, a refrigerator according to some embodiments of the present invention will be described.

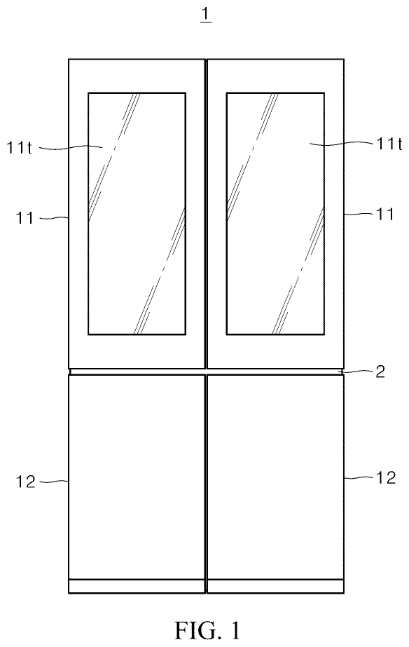

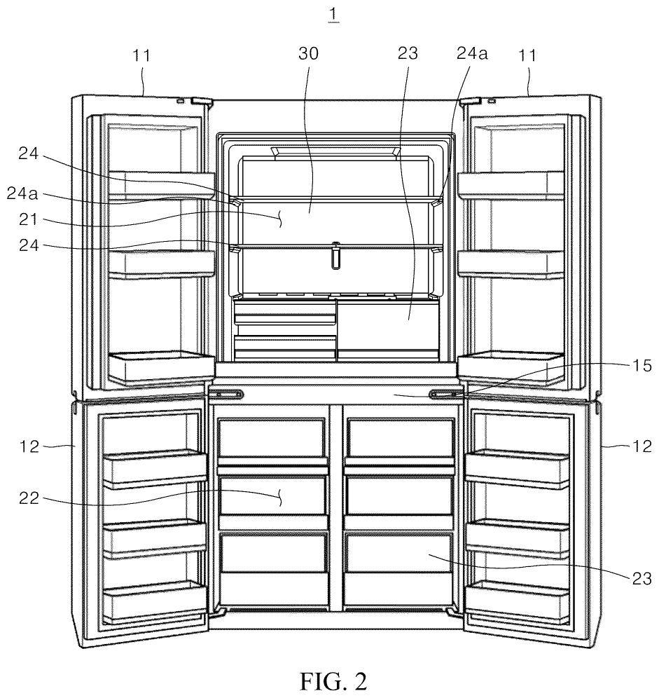

First, with reference to FIGS. 1 and 2, a refrigerator according to an embodiment of the present invention and the connection relationship between respective main components constructing it will be described.

A refrigerator 1 may have an exterior formed by a cabinet 2 including one or more storage chambers therein, which are storage spaces for products, and one or more doors 11, 12 that can open and close the open front surface of the cabinet 2.

The cabinet 2 may include an outer case forming the outer surface of the refrigerator 1 and an inner case forming the inner surface, and the inside of the inner case may be divided into one or more storage spaces.

The cabinet 2 may include one or more storage chambers, for example, a first storage chamber 21 and a second storage chamber 22 disposed in an up and down direction and partitioned by a barrier 15.

As an example, the first storage chamber 21 located at the top may be a cooling chamber, and the second storage chamber 22 located at the bottom may be a freezing chamber.

However, the positions of the first storage chamber 21 and the second storage chamber 22 are not limited thereto, and in other embodiments, the positions of the first storage chamber 21 and the second storage chamber 22 may be swapped with each other, or they may be disposed parallel to each other in a left and right direction.

As described in this specification, an up and down direction, a left and right direction, and a front and rear direction can be described based on the direction in which a user using the refrigerator 1 looks at the front of the refrigerator 1.

In this case, the front of the refrigerator 1 may mean a direction close to the user, and the rear of the refrigerator 1 may mean a direction far from the direction in which the user is located.

On the inner rear of the first storage chamber 21, a lighting assembly 30 may be disposed.

The lighting assembly 30 may be formed as a surface lighting device having a size corresponding to the inner rear surface of the first storage chamber 21.

When the user opens the first door 11, the lighting assembly 30 may be turned on to illuminate the inside of the first storage chamber 21.

However, it is not limited to this, but the on/off of the lighting assembly 30 may be controlled by the controller of the refrigerator 1.

For example, the refrigerator 1 may include various types of sensing devices, such as a proximity sensing device that senses the proximity of a user by measuring the distance from the user, a knock sensing device that senses the door knocking manipulation of the user, an illuminance sensing device that senses the proximity of the user through changes in illuminance, and the like, each of which may be linked to the controller.

Additionally, the lighting assembly 30 may allow its operation to be manipulated or its operating conditions to be set through a remote device located away from the refrigerator 1.

The refrigerator 1 can communicate with the remote device through a communication part connected to the controller, and the user can control the operation of the lighting assembly 30 through the remote device.

The communication part can communicate with a server managing the home appliance and/or the remote device in various ways.

For example, the communication part may have a structure capable of communicating in at least one of wired, wireless, short-range communication (Bluetooth, Wi-Fi, Zigbee, NFC, etc.) or the like.

The aforementioned remote device may be any one of a variety of communication-capable devices such as a dedicated terminal, a mobile phone, a tablet, a portable PC, a desktop PC, a remote control, a Bluetooth speaker, and the like.

The user can manipulate and set the operating state of lighting devices, such as the operating time, operating conditions, light source emission color, or the like of the lighting devices, through the manipulating of the remote device.

For example, easy manipulations and settings may be possible through an application or dedicated program installed on the user's mobile phone.

In each of the first storage chamber 21 and the second storage chamber 22, one or more storage parts 23 and shelf parts 24 for storing food may be disposed.

On the opposite inner side surfaces of the first storage chamber 21, a pair of support parts 24a that respectively support opposite ends of the shelf part 24 can be formed.

The shelf part 24 supported on a pair of support parts 24a may be a wide-type shelf.

In this way, when the shelf part 24 is a wide-type shelf, there is no need for the support part 24a for fixing and supporting the shelf part 24 to be formed in the lighting assembly 30, so that the reduction in the light-emitting area of the lighting assembly 30 disposed at the rear of the shelf part 24 can be decreased while decreasing the interference therewith.

However, it is not limited to this, but the shelf part 24 may be, rather than the wide shelf, a separable shelf in which two shelves are disposed side by side based on a left and right direction of the first storage chamber 21.

In such case where the shelf part 24 is a separable shelf, some of the shelf parts 24 can be freely detached to store internal items of various sizes, so that the space utilization rate of the first storage chamber 21 can be further increased.

In this case, in the central area of the lighting assembly 30, there may be additionally disposed a separate support part which supports one side end of the shelf member 24.

The first door 11 can be rotated to open and close the open front surface of the first storage chamber 21, and the second door 12 can be rotated to open and close the open front surface of the second storage chamber 22.

The first door 11 and the second door 12 may be provided as a pair on the left and right to shield the first storage chamber 21 and the second storage chamber 22, respectively.

However, it is not limited to this, but the first door 11 or the second door 12 may be provided in a non-rotating draw-out or push-in manner, and only one door may be provided for opening and closing each storage chamber.

For example, the first door 11 may include a transparent portion 11t on the front surface, and the user can view the inside of the first storage chamber 21 through the transparent portion 11t even when the first door 11 is closed.

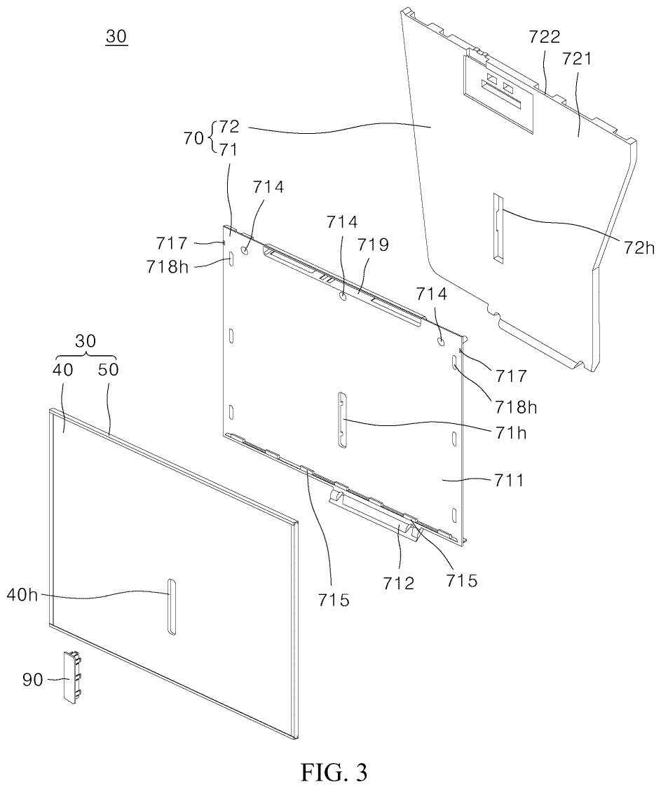

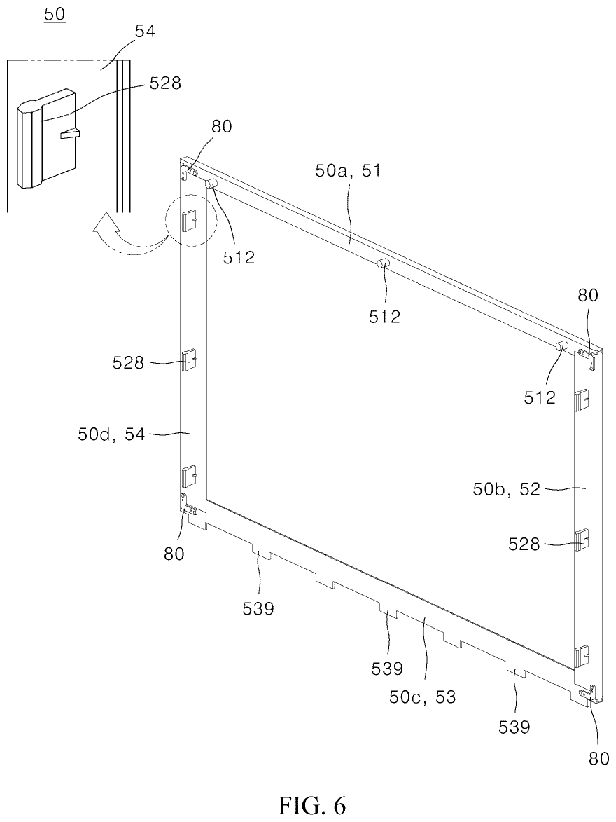

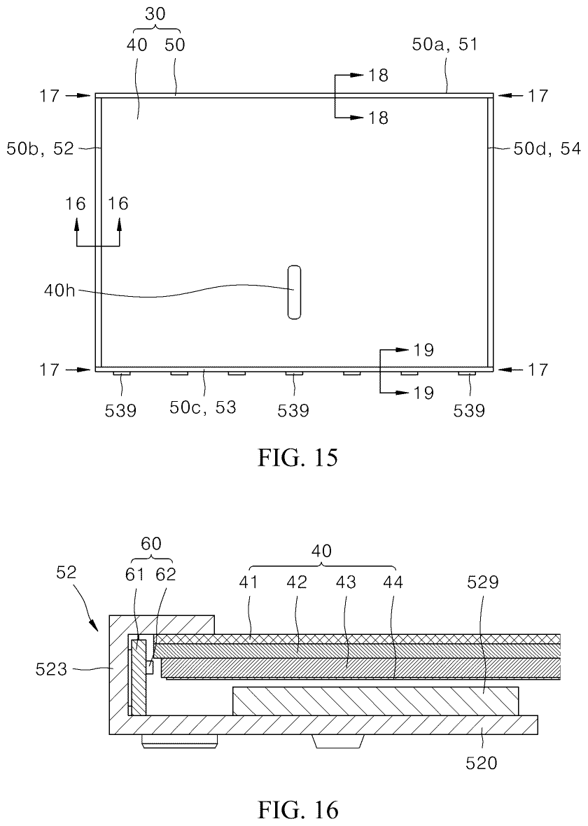

Hereinafter, the lighting assembly 30 and a cold air duct 70 to which the lighting assembly 30 is fixed will be described in detail with further reference to FIGS. 3 to 19.

As described above, on the inner rear of the first storage chamber 21 the lighting assembly 30 may be disposed.

The cold air duct 70 may be disposed between the lighting assembly 30 and the inner rear side of the first storage chamber 21.

The cold air duct 70 may serve to supply cold air to the first storage chamber 21.

For example, in the second storage chamber 22, there may be disposed an evaporator which generates cold air, and a grill fan assembly which blows the cold air generated from the evaporator.

The cold air duct 70 may be communicated with the grill fan assembly, and may discharge the cold air blown from the grill fan assembly into the first storage chamber 21.

The cold air duct 70 may include a duct plate 71 forming a front exterior, and a cold air flow path forming part 72 fixed to the rear surface of the duct plate 71.

The duct plate 71 may include a duct body part 711 formed with a size and shape corresponding to the rear surface of the first storage chamber 21.

In the central region of the duct body part 711, there may be formed a through hole part 71h formed in an up and down direction.

At the bottom of the duct body part 711, there may be formed a connecting part 712 protruding downward.

The connecting part 712 may serve as a connecting passage communicating with the grill fan assembly, and a separate connecting duct may be additionally disposed between the grill fan assembly and the connecting part 712, but it is not limited thereto.

At the rear of the duct body part 711, there may be disposed a duct insulation part 721 formed of an insulating material having a predetermined thickness.

In the duct insulation part 721, there may be formed a cold air flow path 722 which forms a protruding pattern toward the rear of the duct insulation part 721.

The cold air flow path 722 of the duct insulation part 721 may be sealed at the rear surface by being in close contact with the inner case of the cabinet 2 forming the rear surface of the first storage chamber 21.

However, it is not limited thereto, but a duct sheet part having a shape corresponding to the cold air flow path 722 of the duct insulation part 721 may be additionally disposed at the rear of the duct insulation part 721 to cover and seal the cold air flow path 722 formed in the duct insulation part 721.

In the central region of the duct insulation part 721, there may be formed a through hole part 72h formed in an up and down direction.

The through hole part 72h of the cold air flow path forming part 72 may be formed in a shape corresponding to the through hole part 71h of the duct plate 71.

Cold air guided through the cold air flow path 722 of the duct insulation part 721 may be discharged into the first storage chamber 21 through the discharge guide 719 formed in the upper region of the duct plate 71.

According to an embodiment described above as an example in this specification, a separate member such as the duct plate 71 may be disposed on the front surface of the cold air flow path forming part 72 to finish the front surface of the cold air duct 70, and, however, it is not limited thereto, but the front surface of the duct insulation part 721 forming the front surface of the cold air flow path forming part 72 may finish the front surface of the cold air duct 70 without a separate member such as the duct plate 71.

On the front surface of the duct body part 711 of the duct plate 71, a plurality of fastening hole parts 714 may be formed.

As an example, in the top region of the duct body part 711, there may be formed a plurality of fastening hole parts 714 which may be aligned and spaced apart from each other in a left and right direction, but it is not limited thereto.

Additionally, on the front surface of the duct body part 711 of the duct plate 71, a plurality of hook coupling holes 718h may be formed.

As an example, the plurality of hook coupling holes 718h may be formed in the respective opposite side regions of the duct body part 711, and the plurality of hook coupling holes 718h formed in each one of the opposite side regions may be aligned and spaced apart from each other in an up and down direction, but it is not limited thereto.

The above-mentioned fastening holes 714 and hook coupling holes 718h may form a coupling structure that is fastened to the lighting assembly 30 to be described later, and this will be described in detail later.

Additionally, on the front surface of the duct body part 711 of the duct plate 71, one or more wiring holes 717 may be formed.

For example, the wiring hole 717 may be disposed in at least one corner region where the upper region and the side region of the duct body part 711 intersect with each other, and may be formed adjacent to the hook coupling hole 718h located at the top, but it is not limited thereto.

The wiring for supplying signals and power to the lighting assembly 30 can pass through the wiring hole 717.

In the bottom region of the duct plate 71, there may be formed one or more front bent parts 715 which protrude toward the front of the duct plate 71 and are bent upward.

When a plurality of front bent parts 715 are provided, the plurality of front bent parts 715 may be arranged to be spaced apart from each other along a left and right direction of the duct plate 71.

In front of the cold air duct 70 the lighting assembly 30 may be disposed.

The lighting assembly 30 may include a light guiding assembly 40 and a plurality of bezel parts 50 surrounding the periphery of the light guiding assembly 40.

In the central region of the light guiding assembly 40, there may be formed a through hole part 40h formed in an up-down direction.

The through hole part 40h of the light guiding assembly 40 may be formed in a shape corresponding to the through hole part 71h of the duct plate 71 and the through hole part 72h of the cold air flow path forming part 72.

There may be provided a cover member 90 so as to pass through the through hole part 40h of the light guiding assembly 40, the through hole part 71h of the duct plate 71, and the through hole part 72h of the cold air flow path forming part 72 aligned in a front and rear direction of the lighting assembly 30 and the cold air duct 70 as described above, thereby fixing the central regions of the lighting assembly 30 and the cold air duct 70.

Since the lighting assembly 30 is formed as a surface lighting device formed to have a large area, a phenomenon such as distortion due to the weight of the lighting assembly 30 itself and post-deformation of the bezel part 50 constituting the lighting assembly 30 may incur a bulging phenomenon, that is, being loosened and lifted, near the central region of the lighting assembly 30.

In order to reduce the bulging phenomenon that may occur in the lighting assembly 30, the lighting assembly 30 and the cold air duct 70 may be brought into close contact with each other by fastening the lighting assembly 30 and the cooling duct 70 through the separate cover member 90 near the central region.

Therefore, the cover member 90 can function as a anti-lifting cover that can prevent the lighting assembly 30 from being loosened and lifted from the cold air duct 70.

The light guiding assembly 40 may be formed by stacking a plurality of members.

For example, the light guiding assembly 40 may be disposed so that the exterior member 41, the diffusion member 42, the light guiding member 43, and the reflection member 44 are stacked in this order.

The exterior member 41 may be a member that forms the front exterior of the light guiding assembly 40, and may be a finishing member that can show the rear design of the first storage chamber 21 to the user when the lighting assembly 30 is turned off.

The light guiding member 43 can serve to guide light by diffusing or scattering the light.

For example, the light guiding member 43 may be formed of, but not limited to, a polymer material such as PMMA.

On at least one side surface of the light guiding member 43, there may be a pattern part which is formed to have a predetermined pattern, and which can function as a light guiding pattern that reduces total reflection in the light guiding member 43 and allows light to be guided to the front of the light guiding member 43.

The pattern part formed on the light guiding member 43 may be formed in a recessed pattern of a triangular prism form that is arranged to extend along one direction, or in a pattern in which a plurality of hemispherical patterns are arranged spaced apart from each other, but it is not limited thereto, and may be formed to have various shapes of patterns.

The diffusion member 42 formed between the light guiding member 43 and the exterior member 41 can serve to evenly diffuse the light emitted through the light guiding member 43 in the front direction to the maximum extent.

Therefore, the diffusion member 42 can improve the light clarity and light uniformity of the lighting assembly 30.

The reflection member 44 disposed at the rear of the light guiding member 43 can serve to reflect light emitted toward the rear of the light guiding member 43 toward the front of the light guiding member 43.

Therefore, the reflection member 44 can allow light to be emitted to the front of the lighting assembly 30 to the maximum extent, thereby reducing light loss to the maximum extent.

In the central region of the exterior member 41 there may be a through hole 41h formed in an up and down direction; in the central region of the diffusion member 42 there may be a through hole 42h formed in an up and down direction; in the central region of the light guiding member 43 there may be a through hole 43h formed in an up and down direction; and in the central region of the reflection member 44 there may be a through hole 44h formed in an up and down direction.

A plurality of through hole parts 41h, 42h, 43h, 44h formed in this manner may be disposed to be aligned in a shape corresponding to each other, thereby constituting the through hole part 40h of the light guiding assembly 40.

The bezel part 50 surrounding the edge part periphery of the light guiding assembly 40 may be formed to be separable into a plurality of bezels.

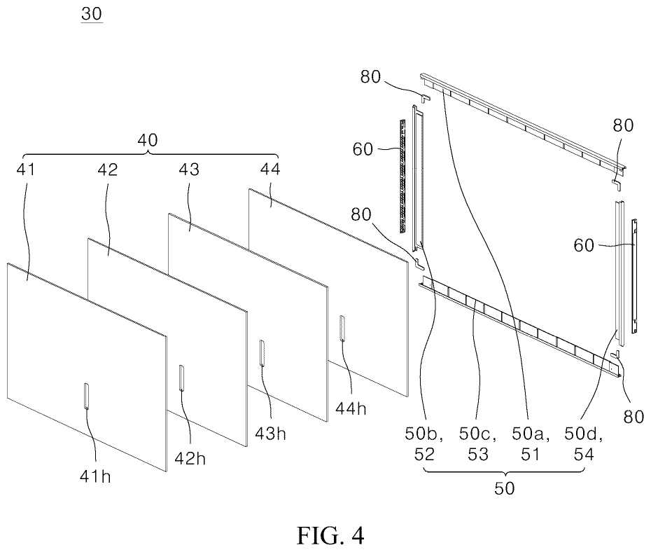

For example, referring to FIG. 4, the bezel part 50 may be configured in a form in which it is separable into four bezels, such as a first bezel 50a, a second bezel 50b, a third bezel 50c, and a fourth bezel 50d.

In this case, the first bezel 50a may be an upper bezel 51 that surrounds the upper surface of the light guiding assembly 40; the second bezel 50b may be a first side bezel 52 that surrounds one side surface of the light guiding assembly 40; the third bezel 50c may be a lower bezel 53 that surrounds the lower surface of the light guiding assembly 40; and the fourth bezel 50d may be a second side bezel 54 that surrounds the other side surface of the light guiding assembly 40.

The first side bezel 52 may be a left bezel forming the left side of the bezel part 50 from the user's point of view, and the second side bezel 54 may be a right bezel forming the right side of the bezel part 50 from the user's point of view.

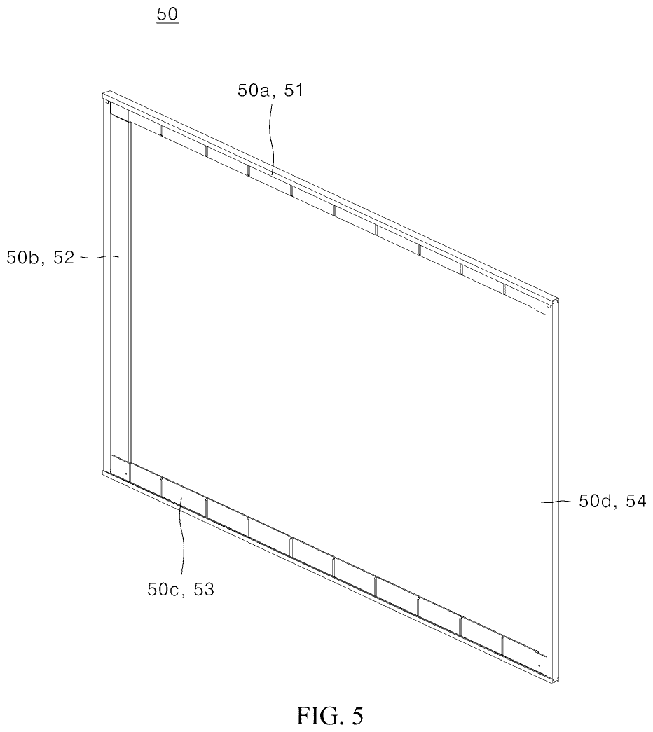

Referring to FIG. 5, the first bezel 50a, the second bezel 50b, the third bezel 50c, and the fourth bezel 50d configured in an above-described manner can form the bezel part 50 surrounding the edge part of the light guiding assembly 40 by fastening adjacent bezels to each other at their ends.

However, the bezel part 50 is not limited to this, and it can be formed in various shapes and separable structures.

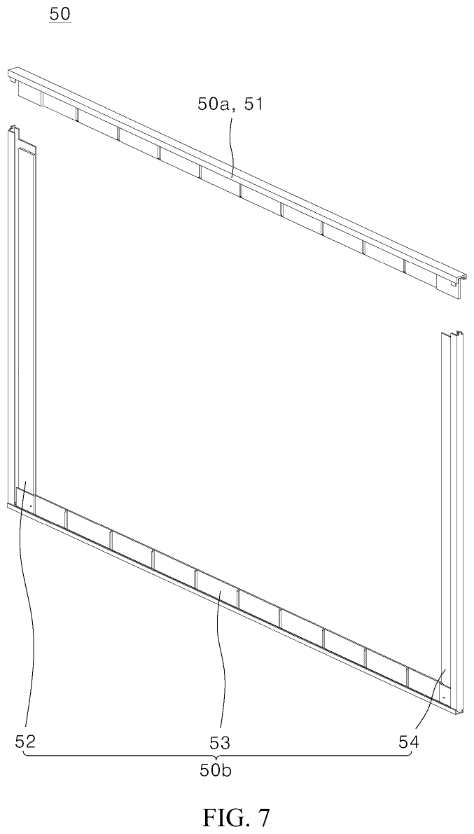

For example, referring to FIG. 7, the bezel part 50 may be separable into a first bezel 50a that surrounds the upper surface of the light guiding assembly 40 and a second bezel 50b that surrounds opposite side surfaces and the lower surface of the light guiding assembly 40, wherein the first and second bezels are fastenable to each other.

In this case, the first bezel 50a may be constituted by the upper bezel 51, and the second bezel 50b may be constituted by the first side bezel 52, the lower bezel 53, and a second side bezel 54 in a one body type.

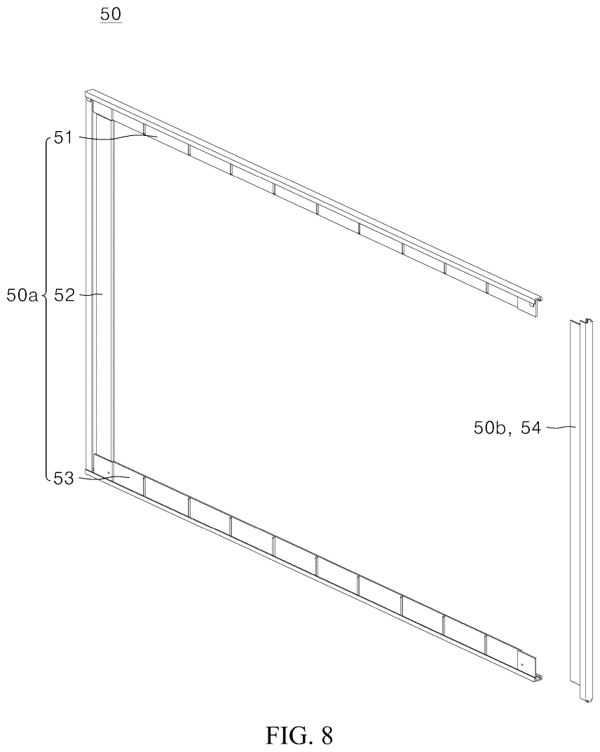

Alternatively, referring to FIG. 8, the bezel part 50 may be separable into a first bezel 50a that surrounds the upper surface, one side surface, and the lower surface of the light guiding assembly 40, and a second bezel 50b that surrounds the other side surface of the light guiding assembly 40, wherein the first and second bezels are fastenable to each other.

In this case, the first bezel 50a may be constituted by the upper bezel 51, the first side bezel 52, and the lower bezel 53 in a one-body type, and the second bezel 50b may be constituted by the second side bezel 54.

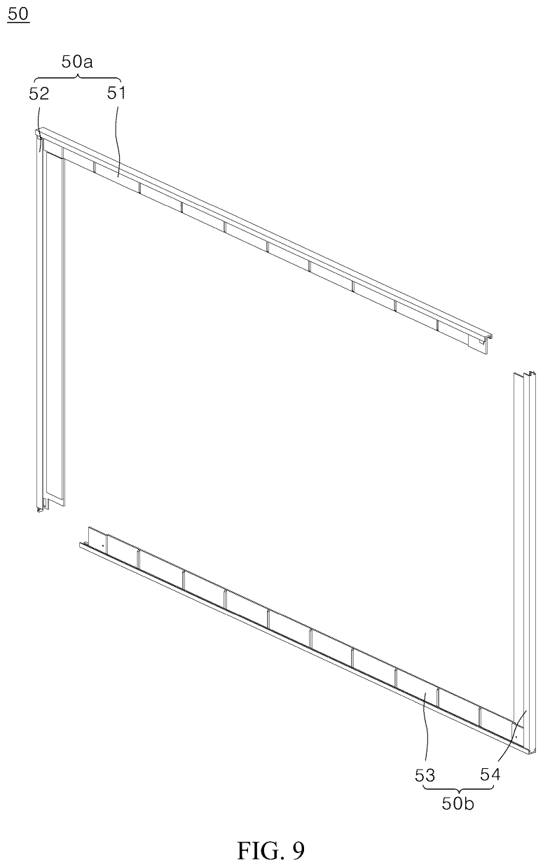

Alternatively, referring to FIG. 9, the bezel part 50 may be separable into a first bezel 50a that surrounds the upper surface and one side surface of the light guiding assembly 40 and a second bezel 50b that surrounds the lower surface and the other side surface of the light guiding assembly 40, wherein the first and second bezels are fastenable to each other.

In this case, the first bezel 50a may be constituted by the upper bezel 51 and the first side bezel 52 in a one-body type, and the second bezel 50b may be constituted by the lower bezel 53 and the second side bezel 54 in a one-body type.

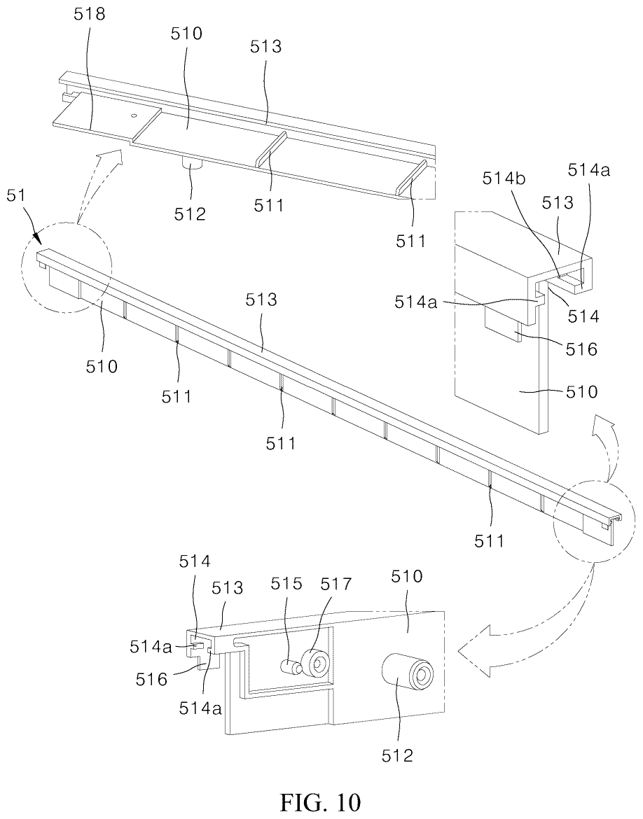

Meanwhile, referring to FIG. 10, the upper bezel 51 may include a first bent body part 513 and a first support body part 510 extending downward from the first bent body part 513.

The upper bezel 51 may be formed so that it extends long in one direction to surround the upper surface of the light guiding assembly 40.

The first bent body part 513 may be formed in a bent shape to surround the front and rear edge parts in the upper region of the light guiding assembly 40 including the upper surface of the light guiding assembly 40.

At both ends of the first bent body part 513, there may be formed first coupling holes 514 which form opening regions opened along the inner directions of the first bent body part 513 extending in one direction.

Accordingly, the first bent body part 513 can be formed to have female bezel structures at both ends.

The first coupling hole 514 may be formed so that its portion is recessed along the inner direction of the first bent body part 513.

On places of the first bent body part 513 where the first coupling holes 514 are formed, there may be formed a pair of first projection stopper parts 514a disposed to be spaced apart downward from the uppermost surface of the first bent body part 513 by a predetermined distance.

A pair of first projection stopper portions 514a may be formed to face each other by protruding from the opposite side surfaces bent downward from the uppermost surface of the first bent body part 513.

Accordingly, the first coupling hole 514 can be formed to have a wide area in the top region where the pair of first projection stopper parts 514a are formed, but a relatively narrow area in the region where the pair of first projection stopper parts 514a face each other.

Due to the structure of the pair of first projection stopper parts 514a formed in this manner, the structure of a male bezel structure to be described later can be prevented from being separated in an up and down direction.

On the inner side of the first projection stopper part 514a, there may be formed a first stopper portion 514b facing in the direction in which the first bent body part 513 is extended.

The first stopper portion 514b may be formed to connect the uppermost surface of the first bent body part 513 and the first projection stopper part 514a.

The first stopper portion 514b formed in this manner can function as a boundary portion that determines the position at which the structure of a male bezel structure inserted into the first coupling hole 514 can be inserted inward.

The first support body part 510 may be formed to extend a predetermined length in the lower direction of the first bent body part 513, and the first support body part 510 may be formed to extend also along one direction in which the first bent body part 513 extends.

The first support body part 510 can substantially serve to support the rear edge part of the top region of the light guiding assembly 40.

On the front surface of the first support body part 510 there may be formed a plurality of first support ribs 511 extending in an up and down direction.

A plurality of first support ribs 511 may be disposed to be spaced apart from each other by a predetermined distance, so that they can be arranged along one direction in which the first support body part 510 extends.

The first support rib 511 may be formed to protrude forward to have a predetermined height.

The first support rib 511 can also serve to reinforce the strength of the first support body part 510.

On the front surfaces of the first support body part 510, which are adjacent to the ends of the first bent body part 513, first step parts 518 may be formed respectively.

The first step part 518 may be formed to protrude forward by a predetermined height by which the first support rib 511 protrudes.

The first step part 518 may be formed to have a predetermined area.

The rear edge part of the top region of the light guiding assembly 40 can be in contact with the first support ribs 511 and first steps 518 of the first support body part 510.

On the rear surface of the first step part 518, there may be formed a first protrusion 515 protruding rearward to have a predetermined height.

Additionally, on the rear surface of the first step part 518 there may be formed a first protruding fastening part 517 protruding rearward to have a predetermined height.

The first protruding fastening part 517 may be formed to have a fastening structure capable of screw-joining with a fastening member such as a screw.

The first protrusion 515 and the first protruding fastening part 517 may be formed in a recessed region having a predetermined area, which is recessed from the rear to the front of the first step part 518.

The first protruding fastening part 517 may be disposed adjacent to the first protruding portion 515.

The first protruding fastening part 517 may be arranged side by side with the first protruding portion 515 in a left and right direction, but it is not limited thereto, but they may be arranged side by side with each other in an up and down direction, or may be arranged side by side with each other in a diagonal direction.

Additionally, the first protruding fastening part 517 may be disposed further inside than the first protrusion 515, but it is not limited thereto, but the first protruding fastening part 517 may be disposed further outside than the first protrusion 515.

The first protruding fastening part 517 and the first protruding part 515 may be fastened to one side of a coupling bracket 80, which is a separate connecting member that connects adjacent bezels to each other.

Additionally, on the rear surface of the first support body part 510 a plurality of fastening bosses 512 may be formed.

The fastening boss 512 may be formed to have a fastening structure capable of screw-joining with a fastening member such as a screw.

For example, a plurality of fastening bosses 512 may be arranged further inside than the first protruding fastening part 517 to be spaced apart from each other at a predetermined interval along one direction in which the first support body part 510 extends.

Specifically, the fastening boss 512 may be formed at a position and in a shape corresponding to the fastening hole part 714 formed on the front surface of the cold air duct 70.

When fixing the lighting assembly 30 to the front surface of the cold air duct 70, the fastening boss 512 of the upper bezel 51 may be inserted into the fastening hole part 714 of the cold air duct 70, and the top region of the lighting assembly 30 may be fixed to the top region of the cold air duct 70 by a separate fastening member such as a screw.

In view of the thickness of the coupling bracket 80 connected to the first protruding fastening part 517 and the first protruding portion 515, it is preferable that the fastening boss 512 be formed to protrude further rearward than the first protruding fastening part 517 and the first protruding portion 515.

On the opposite side to one side among both sides forming the first bent body part 513 where the first support body part 510 is formed, there may be formed a first light leakage blocking extension part 516 extending downward by a predetermined length.

That is, the first support body part 510 may be disposed on the rear surface of the lighting assembly 30, and the first light leakage blocking extension part 516 may be disposed on the front surface of the lighting assembly 30.

The first light leakage blocking extension part 516 may be formed adjacent to the end of the first bent body part 513 to block the light leakage from occurring in the front direction from the corner region where the adjacent bezels are fastened.

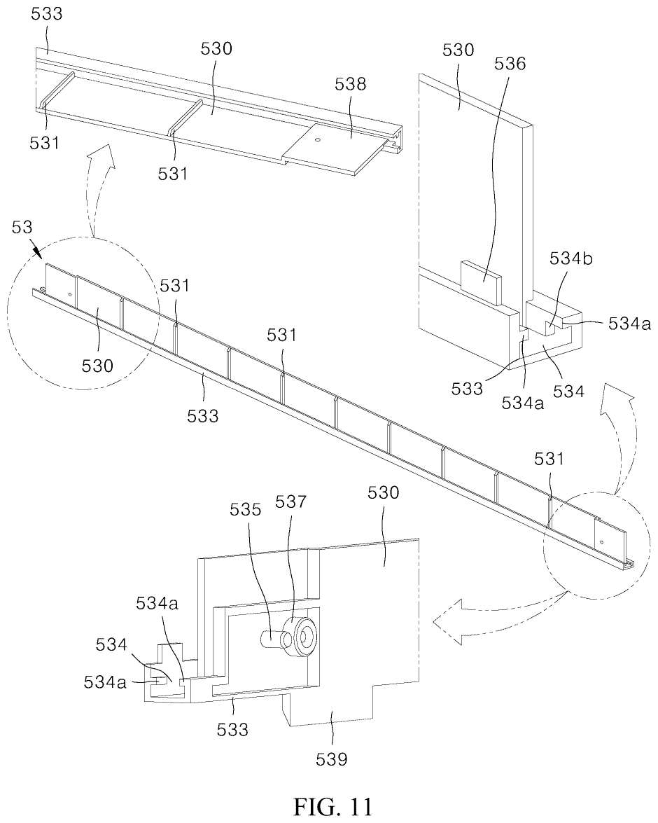

Referring to FIG. 11, the lower bezel 53 may include a third bent body part 533 and a third support body part 530 extending upward from the third bent body part 533.

The lower bezel 53 may be formed to have generally the same structure as that of the upper bezel 51.

The lower bezel 53 may be formed so that it extends long in one direction to surround the lower surface of the light guiding assembly 40.

The third bent body part 533 may be formed in a bent shape to surround the front and rear edge parts in the lower region of the light guiding assembly 40 including the lower surface of the light guiding assembly 40.

At both ends of the third bent body part 533, there may be formed third coupling holes 534 which form opening regions opened along the inner directions of the third bent body part 533 extending in one direction.

Accordingly, the third bent body part 533 can be formed to have female bezel structures at both ends.

The third coupling hole 534 may be formed so that its portion is recessed along the inner direction of the third bent body part 533.

On places of the third bent body part 533 where the third coupling holes 534 are formed, there may be formed a pair of first projection stopper parts 534a disposed to be spaced apart upward from the lowermost surface of the third bent body part 533 by a predetermined distance.

A pair of third projection stopper portions 534a may be formed to face each other by protruding from the opposite side surfaces bent upward from the lowermost surface of the third bent body part 533.

Due to the structure of the pair of third projection stopper portions 534a formed in this manner, the structure of a male bezel structure to be described later can be prevented from being separated in an up and down direction.

On the inner side of the third projection stopper part 534a, there may be formed a third stopper portion 534b facing in the direction in which the third bent body part 533 is extended.

The third stopper portion 534b may be formed to connect the lowermost surface of the third bent body part 533 and the third projection stopper part 534a.

The third stopper portion 534b formed in this manner can function as a boundary portion that determines the position at which the structure of a male bezel structure inserted into the third coupling hole 534 can be inserted inward.

The third support body part 530 may be formed to extend a predetermined length in the upper direction of the third bent body part 533, and the third support body part 530 may be formed to extend also along one direction in which the third bent body part 533 extends.

The third support body part 530 can substantially serve to support the rear edge part of the bottom region of the light guiding assembly 40.

On the front surface of the third support body part 530 there may be formed a plurality of third support ribs 531 extending in an up and down direction.

A plurality of third support ribs 531 may be disposed to be spaced apart from each other by a predetermined distance, so that they can be arranged along one direction in which the third support body part 530 extends.

On the front surfaces of the third support body part 530, which are adjacent to the ends of the third bent body part 533, third step parts 538 may be formed respectively.

The rear edge part of the bottom region of the light guiding assembly 40 can be in contact with the third support ribs 531 and third step parts 538 of the third support body part 530.

On the rear surface of the third step part 538, there may be formed a third protruding part 535 protruding rearward to have a predetermined height.

Additionally, on the rear surface of the third step part 538 there may be formed a third protruding fastening part 537 protruding rearward to have a predetermined height.

The third protruding fastening part 537 may be formed to have a fastening structure capable of screw-joining with a fastening member such as a screw.

The third protruding fastening part 537 may be disposed adjacent to the third protruding portion 535.

The third protruding fastening part 537 and the third protruding part 535 may be fastened to one side of the coupling bracket 80, which is a separate connecting member that connects adjacent bezels to each other.

On the opposite side to one side among both sides forming the third bent body part 533 where the third support body part 530 is formed, there may be formed a third light leakage blocking extension part 536 extending upward by a predetermined length.

That is, the third support body part 530 may be disposed on the rear surface of the lighting assembly 30, and the third light leakage blocking extension part 536 may be disposed on the front surface of the lighting assembly 30.

One or more extension ribs 539 may be formed to extend in a downward direction of the third bent body part 533 by a predetermined length.

For example, the extension rib 539 may be formed to extend toward the downward direction of the third bent body part 533 from the rear surface of the lower bezel 53 where the third support body part 530 is formed.

In the case where a plurality of extension ribs 539 are provided, each extension rib 539 may be formed at a position corresponding to the front bent part 715 formed on the front surface of the bottom region of the duct plate 71.

Each extension rib 539 may be inserted from the upper direction to the lower direction of the front folded portion 715 that is open in the upward direction, and may be supported by the lower surface of the front folded portion 715.

Accordingly, the extension rib 539 of the lower bezel 53 can serve to primarily fix the lighting assembly 30 to the front surface of the cold air duct 70 by inserting the bottom region of the lighting assembly 30 into the front bent part 715 formed in the bottom region of the cold air duct 70.

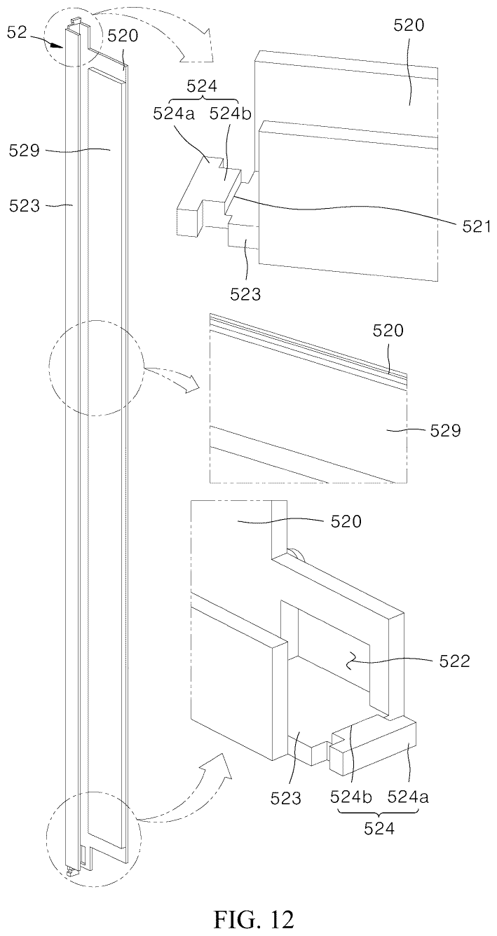

Referring to FIG. 12, the first side bezel 52 may include a second bent body part 523 and a second support body part 520 extending in one direction from the second bent body part 523.

The first side bezel 52 may be formed to extend in one direction so as to surround one side of the light guiding assembly 40.

The second bent body part 523 may be formed in a bent shape to surround the front and rear edges in one side region of the light guiding assembly 40 including one side of the light guiding assembly 40.

At both ends of the second bent body part 523, there may be formed protruding coupling parts 524 that protrude outwardly from the second bent body part 523 extending in one direction.

Accordingly, the second bent body part 523 can be formed to have male bezel structures at both ends.

The protruding coupling part 524 protruding outward from the lower surface of the second bent body part 523 may be formed in a shape in which the width increases as it goes in the outward direction.

For example, the protruding coupling part 524 may be constructed to include a neck 524b having a width in a front and rear direction that is narrower than the width in a front and rear direction of the second bent body part 523, and a head 524a having a width in a front and rear direction that is wider than the width in the front and rear direction of the neck 524b.

The protruding coupling part 524 formed in this manner may be formed in a shape that can be inserted into the first coupling hole 514 and the third coupling hole 534 formed in the upper bezel 51 and the lower bezel 53, respectively to be conformed with them.

For example, the first side bezel 52 may be joined to the upper bezel 51 in a first direction toward the edge part of the light guiding assembly 40.

More specifically, the first side bezel 52 and the upper bezel 51, which are extended so as to be perpendicular to each other, may be fixed to each other by the first side bezel 52 being inserted into the upper bezel 51 in a lateral direction so that the protruding coupling part 524 of the first side bezel 52 can be conformed with the first coupling hole 514 of the upper bezel 51.

Accordingly, by inserting the protruding coupling part 524, which is a male fastening structure, into the first coupling hole 514, which is a female fastening structure, the first side bezel 52 and the upper bezel 51 can be fastened to each other via a male-female coupling structure.

Referring to FIG. 17, the neck 524b of the protruding coupling part 524 can be disposed between a pair of first projection stoppers 514a formed to face each other on the inner sides of the first coupling hole 514 of the upper bezel 51, and the head 524a of the protruding coupling part 524 can be disposed between a pair of first projection stoppers 514a and the uppermost surface of the first bent body part 513.

Accordingly, the head 524a of the protruding coupling part 524 can be restricted from moving in an up and down direction because it is caught by and joined with a pair of first projection stoppers 514a, but can be freely attached and detached in a left and right direction.

Likewise, the first side bezel 52 and the lower bezel 53, which are extended so as to be perpendicular to each other, may be fastened to each other via a male-female coupling structure in the same manner.

The protruding coupling part 524 may be formed to protrude further upward than the upper surface of the second bent body part 523.

Accordingly, a step part 521 can be formed at the boundary between the protruding coupling part 524 and the second bent body part 523.

Accordingly, a pair of step parts 521 can be formed by a pair of protruding coupling parts 524 located at both ends of the second bent body part 523.

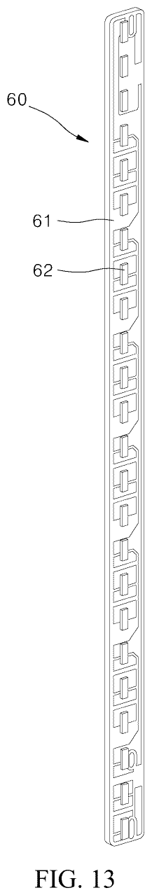

Referring further to FIG. 13, the light source module 60 may include a substrate 61 extending in one direction, and one or more light sources 62 arranged along one direction on one side of the substrate 61.

The light source 62 may be configured to irradiate light of various colors, but it is not limited thereto, and may also irradiate light of one color.

For example, the light source 62 may be constructed by, but is not limited to, an RGB LED (Red Green Blue light emitting diode).

Various components that can apply necessary signals and power to each light source 62 may be disposed on the substrate 61.

The light source module 60 may be disposed to extend in the up and down direction to face one side surface of the light guiding assembly 40 when the first side bezel 52 is joined with the light guiding assembly 40.

Referring to FIG. 16, the light sources 62 of the light source module 60 may be aligned in a left and right direction to face one side surface of the light guiding member 43.

The light guiding assembly 40 extending in the up and down direction in this way may be disposed between a pair of protruding coupling parts 524 located at both ends of the second bent body part 523.

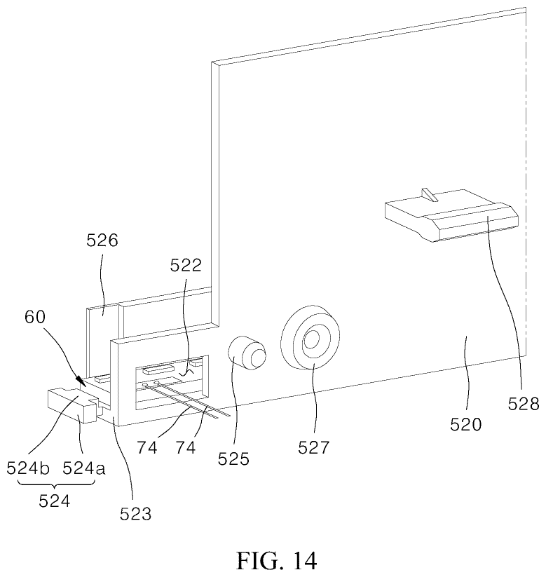

Referring further to FIG. 14, the protruding coupling part 524 that protrudes outwardly from the end of the second bent body part 523 prevents the end of the light guiding assembly 40 from being exposed to the outside when the first side bezel 52 is joined to the upper bezel 51 or the lower bezel 53, thereby preventing the end of the light guiding assembly 40 from being damaged.

In addition, since the light guiding assembly 40 is disposed between a pair of step parts 521 formed by a pair of protruding coupling parts 524 located at both ends of the second bent body part 523, movement in an up-and-down direction can be restricted, thereby preventing the occurrence of positional dispersion of the light guiding assembly 40.

A second support body part 520 may be formed that extends a predetermined length in a lateral direction of the second bent body part 523, and the second support body part 520 may be formed to extend along one direction in which the second bent body part 523 extends.

The second support body part 520 can substantially serve to support the rear edge part of the side region of the light guiding assembly 40.

On the inner surface of the second support body part 520, a buffer member 529 may be disposed along the up and down direction in which the second support body part 520 extends.

The buffer member 529 formed to have a predetermined thickness can serve to support the rear edge part of the side region of the light guiding assembly 40.

In this case, the buffer member 529 may have a thickness sufficient to be in contact with the rear surface of the light guiding assembly 40, thereby alleviating the impact caused by direct contact between the light guiding assembly 40 and the first side bezel 52, but it is not limited thereto.

In addition, the buffer member 529 may be disposed so as to be in close contact with the light guiding assembly 40, thereby reducing moisture penetration to the gap between the first side bezel 52 and the light guiding assembly 40.

Accordingly, since the penetration of moisture into the light source module 60 disposed on the first side bezel 52 can be reduced, the reliability of the light source module 60 with respect to moisture can be increased.

For example, the buffer member 529 may be, but is not limited to, polyethylene foam (PE Foam).

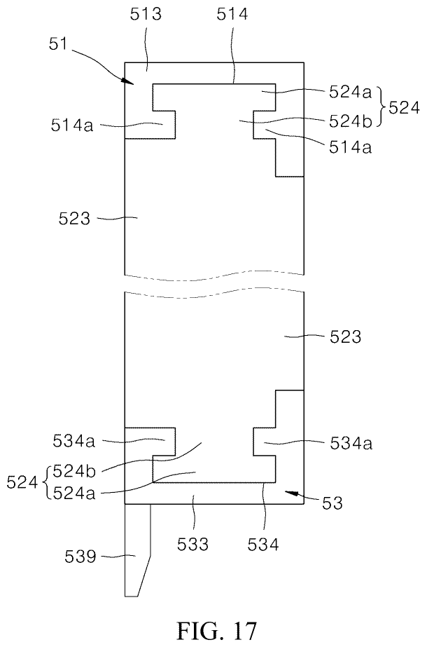

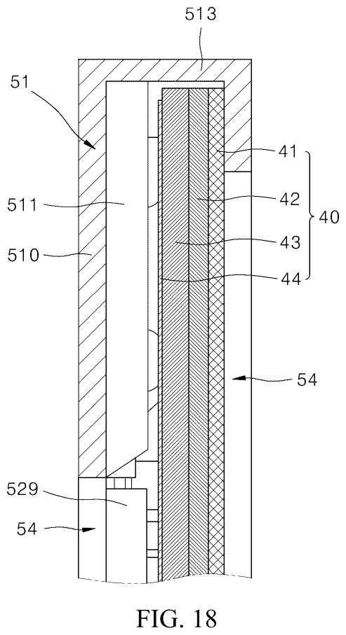

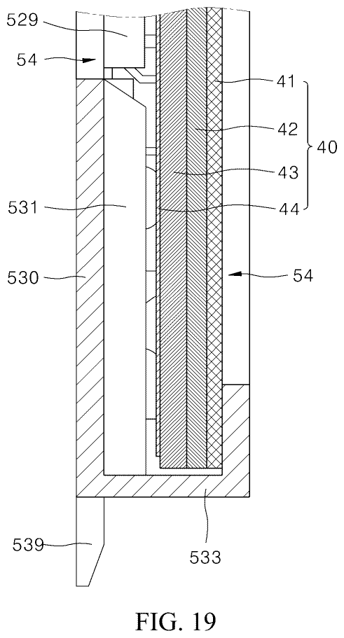

Referring further to FIGS. 18 and 19, the light guiding assembly 40 can be supported at the rear surface by the first support ribs 511 of the upper bezel 51, the buffer members 529 of the first side bezel 52 and the second side bezel 54, and the third support ribs 531 of the lower bezel 53.

Considering that the light guiding member 43 may expand due to the heat of the light source 62, the light guiding assembly 40 may be disposed to be spaced apart from the first support ribs 511, the buffer members 529, and the third support ribs 531 by a predetermined distance.

A wiring passage hole 522 may be formed on one or both sides of the second support body part 520 adjacent to both ends of the first side bezel 52.

The wiring 74 that applies signals and power to the light source module 60 may pass through the wiring through hole 522 and the wiring hole 717 formed on the front of the cold air duct 70 to be connected to the controller or a power application part.

The wirings 74 that apply signals and power may be connected to the light source modules 60, respectively by being separated into separate wirings.

For example, the wiring 74 may be electrically connected to the substrate 61 of the light source module 60 by soldering, but it is not limited thereto.

Since the wiring passage hole 522 is formed on the rear of the first side bezel 52, it is possible to prevent the wiring from being visible to the user, and also to optimize the path along which the wiring pass.

On the rear side of the second support body part 520, there may be formed a second protruding part 525 which protrudes rearward to have a predetermined height.

Additionally, on the rear side of the second support body part 520, there may be formed a second protruding fastening part 527 which protrudes rearward to have a predetermined height.

The second protruding fastening part 527 may be formed to have a fastening structure capable of screw-joining with a fastening member such as a screw.

The second protruding fastening part 527 may be disposed adjacent to the second protruding portion 525.

The second protruding fastening part 527 and the second protruding part 525 may be fastened to one side of the coupling bracket 80, which is a separate connecting member that connects adjacent bezels to each other.

Additionally, on the rear surface of the second support body part 520, a plurality of hook parts 528 may be formed.

The hook part 528 can be inserted into the hook coupling hole 718h formed on the front surface of the cold air duct 70 to be fastened to it in a hook coupling manner.

Accordingly, each hook part 528 can be disposed to correspond to the position of the hook coupling hole 718h.

The hook part 528 and the hook coupling hole 718h formed in this manner enable one side of the lighting assembly 30 to be easily attached to and detached from one side of the cold air duct 70 due to the hook coupling without a separate fastening member.

On the opposite side to one side among both sides forming the second bent body part 523 where the second support body part 520 is formed, there may be formed a second light leakage blocking extension part 526 recessed frontward by a predetermined thickness.

When the first side bezel 52 is fastened to the upper bezel 51 or the lower bezel 53, the first light leakage blocking extension part 516 or the third light leakage blocking extension part 536 can be seated on the second light leakage blocking extension part 526 that is recessed by a predetermined thickness.

More specifically, when the first side bezel 52 is fastened to the upper bezel 51 or lower bezel 53, the second leakage light blocking extension part 526 is disposed to overlap with the first light leakage blocking extension part 516 or the third light leakage blocking extension 536 in a front and rear direction, thereby blocking light leakage which would occur in the front direction in the corner region where adjacent bezels are fastened to each other.

The second side bezel 54 can be formed in a structure symmetrical to the first side bezel 52, so a detailed description thereof will be omitted.

The plurality of bezel parts described above can be connected to one another via a male-female coupling structure.

The male-female coupling structure is a coupling structure in which a male bezel is inserted into a female bezel in a lateral direction, so that the protruding coupling part 524 is inserted into and fastened to the coupling hole 514, 534.

Accordingly, the end of the protruding coupling part 524 can be positioned lower than the uppermost surface of the upper bezel 51, and the protruding coupling parts 524 of the first side bezel 52 and the second side bezel 54 can support the bottom of one side end of the upper bezel 51.

In addition, the end of the protruding coupling part 524 can be positioned higher than the lowermost surface of the lower bezel 53, and one end of the lower bezel 53 can support the bottom of the protruding coupling part 524 of the first side bezel 52 or the second side bezel 54.

As described above, in a male-female coupling structure in which the upper bezel or the lower bezel has a male structure and the side bezel has a female structure, the refrigerator according to the present invention can be configured such that the end of the protruding coupling part is positioned lower than the uppermost surface of the upper bezel or higher than the lowermost surface of the lower bezel, thereby being capable of preventing the bezel from protruding in the up and down direction.

Accordingly, not only can the vertical separation of the male-female coupling structure or the occurrence of an error in the joining position due to the self-weight of the light guiding assembly acting in the downward direction be reduced, but also an improved aesthetic sense of the design finish of the lighting device can be provided to the user.

In addition, the refrigerator according to the present invention can provide, by a plurality of bezels surrounding the periphery of the light guiding assembly and being fastened to one another via a male-female coupling structure, a fitting structure between the bezels, which is capable of minimizing the fastening structure step between the bezels even in a storage chamber with limited space.

In addition, the refrigerator according to the present invention can reduce, by a plurality of bezels surrounding the periphery of the light guiding assembly and being fastened to one another via a male-female coupling structure, the reliability deterioration of the fitting structure between the bezels even when thermal deformation occurs in the bezels due to the heat of the light source module.

In addition, the refrigerator according to the present invention can, by forming a plurality of bezel parts fastened to one another in a male-female coupling structure as injection molding products including a material having electrical insulation property, have an electrostatic discharge (ESD) prevention function that prevents static electricity from being introduced into a storage chamber through the bezel part in contact with the light source module, and also allow the bezel part to be formed quickly and easily to have male-female coupling structures of various shapes.

In addition, in a male-female coupling structure in which the upper bezel or the lower bezel has a male structure and the side bezel has a female structure, the refrigerator according to the present invention can reduce, by allowing a protruding coupling part of the male bezel to be inserted into a coupling hole of the female bezel in a lateral direction, the occurrence of an error in the joining position or the separation of the male-female coupling structure in the up and down direction due to the self-weight of the light guiding assembly acting in a downward direction.

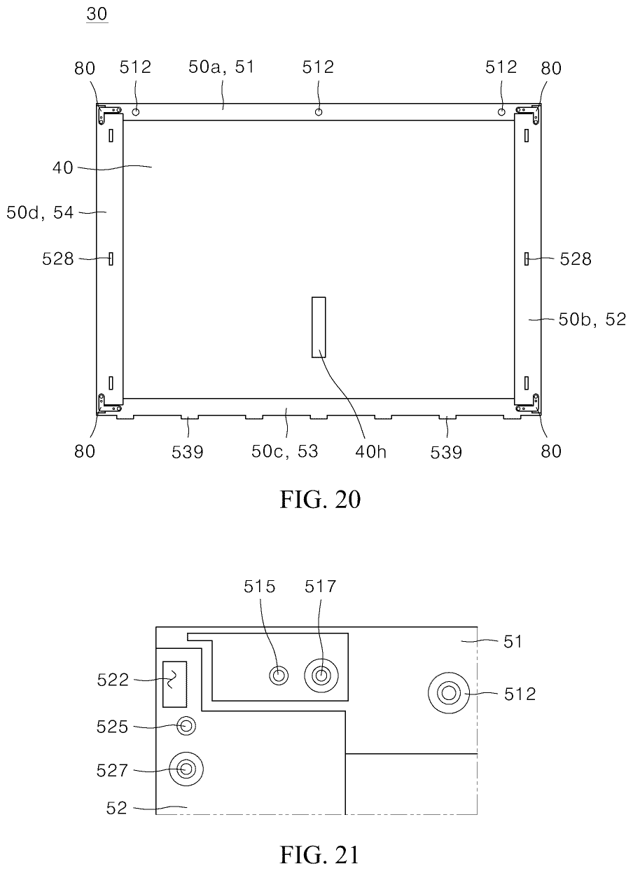

Referring further to FIGS. 20 to 24, on the rear of the lighting assembly 30 there may be further disposed a plurality of coupling brackets 80 which connect a plurality of adjacent bezel parts to one another.

As described above, a plurality of adjacent bezel parts, for example, the first bezel 50a and the second bezel 50b, may be joined to each other in the first direction.

In this case, the first direction may be a direction toward the side surface of the edge part of the light guiding assembly 40, for example, a left and right direction of the first storage chamber 21.

The coupling bracket 80 may be joined to a plurality of bezel parts adjacent to each other in a second direction perpendicular to the first direction.

In this case, the second direction may be the light-emitting direction of the lighting assembly 30, for example, a front and rear direction of the first storage chamber 21.

One side and the other side of the coupling bracket 80 may be fastened to the rear surface of the first bezel 50a and the rear surface of the second bezel 50b, respectively.

For example, the coupling bracket 80 may be formed to include a first bracket extension part 81 extending along the extension direction of the first bezel 50a, a second bracket extension part 82 extending along the extension direction of the second bezel 50b, and a bent part 83 connecting between the first bracket extension part 81 and the second bracket extension part 82.

In this case, the first bracket extension part 81 and the second bracket extension part 82 may be connected at the bent part 83 so that they are perpendicular to each other based on the bent part 83.

In the first bracket extension part 81, there may be formed a first through hole 81h and a second through hole 82h through which the first protruding part 515 and first protruding fastening part 517 of the lighting assembly 30 pass, respectively.

The first protruding part 515 can be disposed to penetrate through the first through hole 81h of the first bracket extension part 81, so that it can restrict movements of adjacent bezel parts in up, down, left, and right directions.

In addition, the first protruding fastening part 517 and the second through hole 82h can be disposed to be aligned with each other, and the first bracket extension part 81 can be fastened to the lighting assembly 30 by a separate fastening member 88 such as a screw, so that the coupling bracket 80 can be pressed in the second direction, thereby further strengthening the fastening force between adjacent bezel parts.

Similarly, in the second bracket extension part 82, there may be formed a first through hole 81h and a second through hole 82h through which the second protruding part 525 and second protruding fastening part 527 of the lighting assembly 30 pass, respectively.

The second protruding part 525 can be disposed to penetrate through the first through hole 81h of the second bracket extension part 82, so that it can restrict movements of adjacent bezel parts in up, down, left, and right directions.

In addition, the second protruding fastening part 527 and the second through hole 82h can be disposed to be aligned with each other, and the second bracket extension part 82 can be fastened to the lighting assembly 30 by a separate fastening member 88 such as a screw, so that the coupling bracket 80 can be pressed in the second direction, thereby further strengthening the fastening force between adjacent bezel parts.

Referring to FIG. 23, the coupling bracket 80 can be disposed to be spaced apart from the wiring through hole 522 formed in the first side bezel 52 by a predetermined distance, thereby preventing the wiring passing through the wiring through hole 522 from being interfered with by the coupling bracket 80.

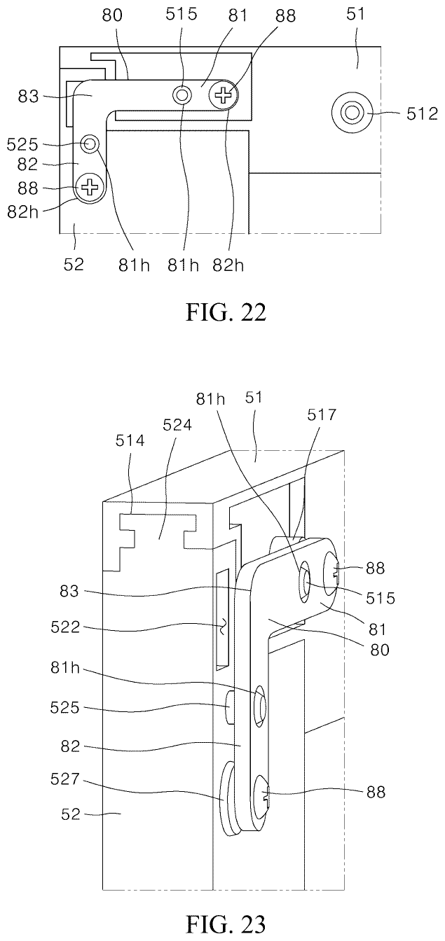

Although the description has been made, in the case of FIGS. 21 and 22, based on the corner region where the upper bezel 51 and the first side bezel 52 are fastened to each other, a separate coupling bracket 80 may be fastened to the lighting assembly 30 in the same manner in the corner region where the first side bezel 52 and the lower bezel 53 are fastened to each other, the corner region where the lower bezel 53 and the second side bezel 54 are fastened to each other, or the corner region where the second side bezel 54 and the upper bezel 51 are fastened to each other.

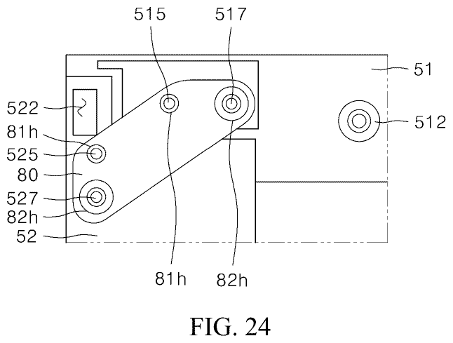

Referring to FIG. 24, the coupling bracket 80 may be formed in a plate shape having no separate bent part.

In this case, on each of one side and the other side of the coupling bracket 80, there may be a pair of first through hole 81h and second through hole 82h which are formed so that they can be fastened with the first protruding part 515 and the first protruding fastening part 517, or the second protruding part 525 and the second protruding fastening part 527.

In this case, since the coupling bracket 80 is formed so that it does not overlap with at least some region of the wiring through hole 522 in a front and rear direction, interference with the wiring passing through the wiring through hole 522 can be further reduced.

As described above, the refrigerator according to the present invention can reduce the occurrence of deformation or distortion of the bezel that may occur due to thermal deformation or the self-weight of the light guiding assembly, and also reinforce the strength of the fitting structure between the bezels, by joining in a first direction a plurality of bezel parts adjacent to each other and additionally disposing a coupling bracket in a second direction perpendicular to the first direction to be joined to a plurality of bezel parts adjacent to each other.

What is claimed is:

1. A refrigerator comprising:
a cabinet including one or more storage chambers; and
a lighting assembly disposed at an inner rear portion of the storage chamber,
wherein the lighting assembly includes a light guiding assembly, a plurality of bezel parts surrounding a periphery of the light guiding assembly, and a light source module configured to irradiate light to the light guiding assembly, and
wherein the plurality of bezel parts adjacent to each other are joined to each other via a male-female coupling structure.

2. The refrigerator of claim 1, wherein:
the plurality of bezel parts include one or more male bezels and one or more female bezels;
the male bezel includes a protruding coupling part protruding outward from at least one end; and
the female bezel includes a coupling hole recessed inward from at least one end for the protruding coupling part to be inserted into.

3. The refrigerator of claim 2, wherein the male-female coupling structure is a coupling structure in which the male bezel is inserted in a lateral direction of the female bezel, so that the protruding coupling part is inserted into and fastened to the coupling hole.

4. The refrigerator of claim 2, wherein:
the male bezel is a side bezel extending in an up and down direction of the light guiding assembly to surround one side surface of the light guiding assembly;
the female bezel is an upper bezel extending in a left and right direction of the light guiding assembly to surround an upper surface of the light guiding assembly; and
the end of the protruding coupling part is positioned lower than an uppermost surface of the upper bezel.

5. The refrigerator of claim 4, wherein the protruding coupling part of the side bezel supports an underside of one lateral end of the upper bezel.

6. The refrigerator of claim 4, wherein:
the side bezel includes a pair of the protruding coupling parts protruding outward from both ends;
the light source module is disposed in the side bezel so that it extends in an up and down direction to face the side surface of the light guiding assembly; and
the light source module is disposed between the pair of protruding coupling parts.

7. The refrigerator of claim 2, wherein:
the male bezel is a side bezel extending in an up and down direction of the light guiding assembly to surround another side surface of the light guiding assembly;
the female bezel is a lower bezel extending in a left and right direction of the light guiding assembly to surround a lower surface of the light guiding assembly; and
the end of the protruding coupling part is positioned higher than a lowermost surface of the lower bezel.

8. The refrigerator of claim 7, wherein one side end of the lower bezel supports an underside of the protruding coupling part of the side bezel.

9. The refrigerator of claim 7, wherein:
the side bezel includes a pair of the protruding coupling parts protruding outward from both ends;
the light source module is disposed in the side bezel so that it extends in an up and down direction to face the side surface of the light guiding assembly; and
the light source module is disposed between the pair of protruding coupling parts.

10. A refrigerator comprising:
a cabinet including one or more storage chambers; and
a lighting assembly disposed at an inner rear portion of the storage chamber,
wherein:
the lighting assembly includes a light guiding assembly, a plurality of bezel parts surrounding a periphery of the light guiding assembly, a coupling bracket connecting the plurality of bezel parts adjacent to each other, and one or more light source modules irradiating light to the light guiding assembly;
the plurality of bezel parts adjacent to each other are joined to each other in a first direction; and
the coupling bracket is joined to the plurality of bezel parts adjacent to each other in a second direction perpendicular to the first direction.

11. The refrigerator of claim 10, wherein the first direction is a direction toward the periphery of the light guiding assembly, and
wherein the second direction is a light-emitting direction of the lighting assembly.

12. The refrigerator of claim 10, wherein the plurality of bezel parts include a first bezel and a second bezel, and
wherein the first bezel and the second bezel are extended perpendicular to each other and fastened at their respective ends thereof via a male-female coupling structure.

13. The refrigerator of claim 12, wherein one side of the coupling bracket is fastened to a rear surface of the first bezel, and an opposite side of the coupling bracket is fastened to a rear surface of the second bezel.

14. The refrigerator of claim 13, wherein the coupling bracket includes a first bracket extension part extending along an extension direction of the first bezel, a second bracket extension part extending along an extension direction of the second bezel, and a bent part connecting between the first bracket extension part and the second bracket extension part.

15. The refrigerator of claim 13, further comprising a plurality of fastening members that respectively fasten the one side and the opposite side of the coupling bracket to the rear surface of the first bezel and the rear surface of the second bezel,
wherein the plurality of fastening members press the coupling bracket in the second direction.

16. The refrigerator of claim 13, wherein a first protruding part and a second protruding part are respectively disposed on the rear surface of the first bezel and the rear surface of the second bezel to projecting rearward, and
wherein the coupling bracket includes a first through hole and a second through hole through which the first protruding part and the second protruding part penetrate, respectively.

17. The refrigerator of claim 10, wherein the plurality of bezel parts include an upper bezel and a lower bezel that surround upper and lower surfaces of the light guiding assembly, respectively, and
wherein each of the upper bezel and the lower bezel includes one or more support ribs that support a rear surface of the light guiding assembly.

18. The refrigerator of claim 10, wherein the plurality of bezel parts include a pair of side bezels respectively surrounding both side surfaces of the light guiding assembly, and
wherein the light source module is disposed on each of the side bezels so as to face the periphery of the light guiding assembly.

19. The refrigerator of claim 18, wherein each of the pair of side bezels has a buffer member disposed thereon to support a rear surface of the light guiding assembly.

20. The refrigerator of claim 10, further comprising a cold air duct disposed on a rear surface of the lighting assembly,
wherein the bezel part has one or more hook parts on a rear surface thereof, and
wherein the cold air duct has one or more hook coupling holes in a front surface thereof, which the hook part is inserted into and fastened to.
